(19) United States
(12) Patent Application Publication
(10) Pub. No.: US 2025/0315742 A1
(43) Pub. Date: Oct. 9, 2025

(54) METHOD OF AND SYSTEM FOR GENERATING A FLIGHT LEG UNIQUE IDENTIFIER (FLUID)

(71) Applicant: CAE FLIGHT SERVICES USA, INC.

(72) Inventor: Rafal SUCHOCKI, Irving, TX (US)

(73) Assignee: CAE FLIGHT SERVICES USA, INC., (omitted)

(21) Appl. No.: 19/170,149

(22) Filed: Apr. 4, 2025

(30) Foreign Application Priority Data
Apr. 4, 2024 (CA) 3234108

(51) Int. Cl. G06Q 10/02; G06F 7/58

(52) U.S. Cl. CPC G06Q 10/025; G06F 7/582

(57) ABSTRACT

There is provided a method, system, and non-transitory storage medium for generating and transmitting a flight leg unique identifier (FLUID) for a flight leg. A request for a new flight leg is received from a source system, with at least one field of the new flight leg recorded in the source. A flight leg unique identifier (FLUID) is generated, the FLUID comprising a first portion, a second portion and a third portion. The first portion of the FLUID is generated based on a timestamp associated with the new flight leg. The second portion of the FLUID is generated based on an identification of the source system of the request. The third portion of the FLUID is generated based on a random number. The FLUID is transmitted with the at least one field of the new flight leg to the source system.

### CROSS-REFERENCE TO RELATED APPLICATIONS

The present patent application claims priority on Canadian Patent Application No. 3,234,108 filed on Apr. 4, 2024, the content of which is incorporated herein by reference.

### FIELD

The present technology relates to flight operations in general and more specifically to methods and systems for generating, transmitting and maintaining a flight leg unique identifier (FLUID).

### BACKGROUND

Historically, software solutions have used some variation of a “Business Key” to attempt to identify flights. Such keys are typically made up various specific identifying attributes of a given flight. Such attributes may contain, but are not limited to: airline code (2 or 3 letters), flight number, departure station, operations date, and scheduled time of departure

While this kind of business logic works in many cases, it has been frequently noted that Irregular Operations (IROps) do not function well as it becomes increasingly likely that two distinct aircraft movement will have identical identifying information.

One alternative proposed to the industry was the Globally Unique Flight Identifier (GUFI). With GUFI, the International Civil Aviation Organization (ICAO) attempted to create a unique identifier for each flight movement reported to the Air Traffic Management facilities around the world. However, some flaws were present in the proposed system.

The pseudo-random number associated with each flight was limited in the number of characters that it could use, which in turn limited the number of unique IDs that were available globally. This limitation meant that GUFI's would start repeating after a relatively short time.

ICAO established that using GUFI for “ . . . business processing . . . ” would be a violation of “requirement 7 in reference 1” of the description document for GUFI. This means that GUFI could only be used to identify flights with Air Traffic Control and could not be used internally to a solutions database for integration purposes.

### SUMMARY

It is an object of the present technology to ameliorate at least some of the inconveniences present in the prior art. One or more implementations of the present technology may provide and/or broaden the scope of approaches to and/or methods of achieving the aims and objects of the present technology.

One or more implementations of the present technology have been developed based on developers' appreciation that there is a need for a system and a method for uniquely identifying flight legs, where the unique identifier is globally unique, does not prohibit usage of other identifiers for flight legs, matches across different domains in the context of aircraft operations, cannot be modified, and that is used identification purposes.

Thus, one or more implementations of the present technology are directed to a method, system and non-transitory computer-readable storage medium for generating and transmitting a flight leg unique identifier (FLUID).

In accordance with a broad aspect of the present technology, there is provided a method for generating and transmitting a flight leg unique identifier (FLUID) for a flight leg, the method being executed by at least one processor, the at least one processor being connected to a source system. The method comprises: receiving, from the source system, a request for a new flight leg, with at least one field of the new flight leg recorded in the source system, generating a flight leg unique identifier (FLUID), the FLUID, the FLUID comprising a first portion, a second portion and a third portion, said generating the FLUID comprising: generating the first portion of the FLUID based on a timestamp associated with the new flight leg, generating the second portion of the FLUID based on an identification of the source system of the request, and generating the third portion of the FLUID based on a random number, and transmitting the FLUID with the at least one field of the new flight leg to the predetermined source system.

In one or more implementations, the method is encoded as a set of computer-readable instructions in at least one non-transitory storage medium.

In one or more implementations of the method, the request further comprises an indication of the new flight leg, and the at least one processor is further configured to transmit the FLUID together with the indication of the new flight leg.

In one or more implementations of the method, the timestamp corresponds to a creation time of the new flight leg.

In one or more implementations of the method, the timestamp corresponds to a reception time of the request.

In one or more implementations of the method, said generating the third portion of the FLUID comprises: generating, using a pseudo random number generator (PRNG), the random number.

In one or more implementations of the method, the FLUID is in hexadecimal format.

In one or more implementations of the method, the first portion of the FLUID comprises 11 characters, the second portion of the FLUID comprises 3 characters, and the third portion of the FLUID comprises 12 characters.

In one or more implementations of the method, the FLUID comprises a fourth portion having 1 character positioned between the first portion and the second portion, and a fifth portion having 1 character positioned between the second portion and the third portion.

In one or more implementations of the method, FLUID has a fixed length of 28 characters.

In one or more implementations of the method, the source system comprises one of a schedule management system and a flight operation control system.

In one or more implementations of the method, the request comprises the identification of the source system.

In one or more implementations of the method, the at least one processor is operatively connected to a database and configured to store the FLUID with the indication of the new flight leg in the database.

In one or more implementations of the method, the method further comprises: transmitting the FLUID to another system.

In accordance with a broad aspect of the present technology, there is provided a system for generating and transmitting a flight leg unique identifier (FLUID) for a flight leg, the system comprising: a non-transitory storage medium storing computer-readable instructions thereon, and at least one processor operatively connected to the non-transitory storage medium. the at least one processor, upon executing the computer-readable instructions is configured for: receiving, from a source system, a request for a new flight leg, with at least one field of the new flight leg recorded in the source system, generating a flight leg unique identifier (FLUID), the FLUID comprising a first portion, a second portion and a third portion, said generating the FLUID comprising: generating the first portion of the FLUID based on a timestamp associated with the new flight leg, generating the second portion of the FLUID based on an identification of the source system of the request, and generating the third portion of the FLUID based on a random number, and transmitting the FLUID with the at least one field of the new flight leg to the source system.

In one or more implementations of the system, the request further comprises an indication of the new flight leg, and the at least one processor is further configured for transmitting the FLUID together with the indication of the new flight leg.

In one or more implementations of the system, the timestamp corresponds to a creation time of the new flight leg.

In one or more implementations of the system, the timestamp corresponds to a reception time of the request.

In one or more implementations of the system, said generating the third portion of the FLUID comprises: generating, using a pseudo random number generator (PRNG), the random number.

In one or more implementations of the system, the FLUID is in hexadecimal format.

In one or more implementations of the system, the first portion of the FLUID comprises 11 characters, the second portion of the FLUID comprises 3 characters, and the third portion of the FLUID comprises 12 characters.

In one or more implementations of the system, the FLUID comprises a fourth portion having 1 character positioned between the first portion and the second portion, and a fifth portion having 1 character positioned between the second portion and the third portion.

In one or more implementations of the system, the FLUID has a fixed length of 28 characters.

In one or more implementations of the system, the source system comprises one of a schedule management system and a flight operation control system.

In one or more implementations of the system, the request comprises the identification of the source system.

In one or more implementations of the system, the at least one processor is operatively connected to a database and configured to store the FLUID with the indication of the new flight leg in the database.

In one or more implementations of the system, the at least one processor is further configured for: transmitting the FLUID to another system different from the source system.

### Terms and Definitions

In the context of the present specification, a “server” is a computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “computing device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates a schematic diagram of a computing device in accordance with one or more non-limiting implementations of the present technology.

FIG. 2 illustrates a schematic diagram of a computing environment in accordance with one or more non-limiting implementations of the present technology.

FIG. 3 illustrates a schematic diagram of a flight services communication platform implemented within the computing environment of FIG. 2 in accordance with one or more non-limiting implementations of the present technology.

FIG. 4 illustrates a non-limiting example of a flight leg unique identifier (FLUID) generated within the system of FIG. 3.

FIG. 5 illustrates a flow chart of a method of generating a flight leg unique identifier (FLUID) in accordance with one or more non-limiting implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting implementations of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computing Device

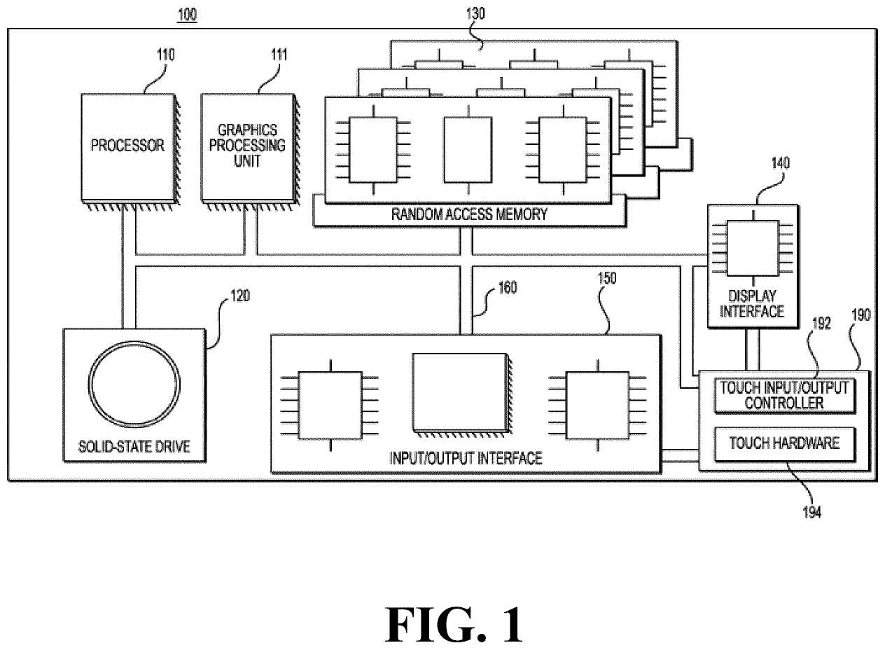

Referring to FIG. 1, there is shown a computing device 100 suitable for use with some implementations of the present technology, the computing device 100 comprising various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computing device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more implementations, the touchscreen 190 is the display. The touchscreen 190 may equally be referred to as a screen 190. In the implementations illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more implementations, the input/output interface 150 may be connected to a keyboard (not shown), a mouse (not shown) or a trackpad (not shown) allowing the user to interact with the computing device 100 in addition or in replacement of the touchscreen 190.

According to implementations of the present technology, the solid-state drive 120 stores program instructions suitable for being loaded into the random-access memory 130 and executed by the processor 110 and/or the GPU 111 for generating a flight leg unique identifier (FLUID). For example, the program instructions may be part of a library or an application.

The computing device 100 may be implemented as a server, a desktop computer, a laptop computer, a tablet, a smartphone, a personal digital assistant or any device that may be configured to implement the present technology, as it may be understood by a person skilled in the art.

### System

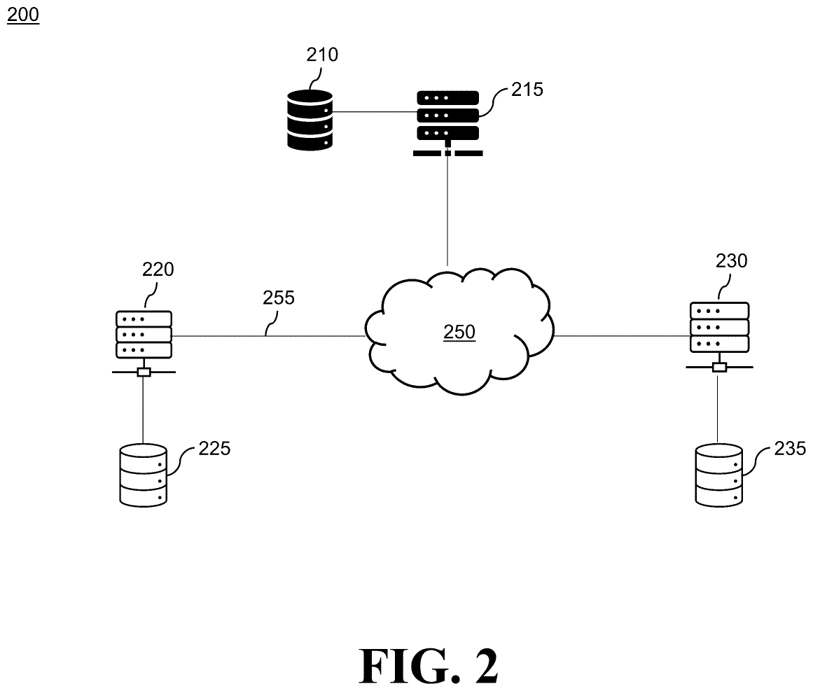

Referring to FIG. 2, there is shown a schematic diagram of a computing environment 200, the computing environment 200 being suitable for implementing one or more non-limiting implementations of the present technology. It is to be expressly understood that the computing environment 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the computing environment 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the computing environment 200 may provide in certain instances simple implementations of the present technology, and that where such is the case they have been presented in this manner as an aid to understanding. As persons skilled in the art would understand, various implementations of the present technology may be of a greater complexity.

The computing environment 200 comprises inter alia a first server 210, a second server 220 and a third server 230 communicatively coupled over a communication network 250.

### Servers

The first server 210, the second server 220 and the third server 230 may be implemented in a similar manner. In one or more implementations, each of the first server 210, the second server 220 and the third server 230 may be operated by a different entity (e.g., company, government, user(s), etc.) for the purpose of the methods and system described herein.

While only three servers 210, 220, 230 are illustrated, it will be appreciated that dozens, hundreds and thousand servers may be used in the context of the present technology.

It will be appreciated that a given one of the first server 210, the second server 220, and the third server 230 can be implemented as a conventional computer server and may comprise at least some of the features of the computing device 100 shown in FIG. 1. In a non-limiting example of one or more implementations of the present technology, the given one of the first server 210, the second server 220, and the third server 230 is implemented as a server running an operating system (OS). Needless to say that a given one of the first server 210, the second server 220, and the third server 230 may be implemented in any suitable hardware and/or software and/or firmware or a combination thereof. In the disclosed non-limiting implementation of present technology, each given one of the first server 210, the second server 220, and the third server 230 is a single server.

In one or more alternative non-limiting implementations of the present technology, the functionality of a given one of the first server 210, the second server 220, and the third server 230 may be distributed and may be implemented via multiple servers (not shown).

The implementation of given one of the first server 210, the second server 220, and the third server 230 is well known to the person skilled in the art. However, the given one of the first server 210, the second server 220, and the third server 230 comprises a communication interface (not shown) configured to communicate with various entities (such as the databases 215, 225 and 235, for example and other devices potentially coupled to the communication network 250) via the communication network 250. The given one of the first server 210, the second server 220, and the third server 230 further comprises at least one computer processor (e.g., the processor 110 and/or GPU 111 of the computing device 100) operationally connected with the communication interface and structured and configured to execute various processes to be described herein.

Each one of the first server 210, the second server 220 and the third server 230 is connected to a respective database, i.e., the first server 210 has a first database 215, the second server 220 has a second database 225 and the third server 230 has a third database 235.

### Databases

Each one of the databases 215, 225, and 235 may be directly coupled to the respective one of the first server 210, the second server 220, and the third server 230 but, in one or more alternative implementations, without departing from the teachings of the present technology, one or more of the databases 215, 225, and 235 may be communicatively coupled via the communication network 250. Although each one of the databases 215, 225, and 235 is illustrated schematically herein as a single entity, it will be appreciated that each one of the databases 215, 225, and 235 may be configured in a distributed manner, for example, each one of the databases 215, 225, and 235 may have different components, each component being configured for a particular kind of retrieval therefrom or storage therein.

Each one of the databases 215, 225, and 235 may be a structured collection of data, irrespective of its particular structure or the computer hardware on which data is stored, implemented or otherwise rendered available for use. A given one of the databases 215, 225, and 235 may reside on the same hardware as a process that stores or makes use of the information stored in the given one of the databases 215, 225, and 235 or it may reside on separate hardware, such as on the respective one of the first server 210, the second server 220, and the third server 230.

The given one of the databases 215, 225, and 235 may receive data from one or more of the first server 210, the second server 220, and the third server 230 for storage thereof and may provide stored data to one or more of the first server 210, the second server 220, and the third server 230 for use thereof.

### Communication Network

In one or more implementations of the present technology, the communications network 240 is the Internet. In one or more alternative non-limiting implementations, the communication network 250 may be implemented as any suitable local area network (LAN), wide area network (WAN), a private communication network or the like. It will be appreciated that implementations for the communication network 250 are for illustration purposes only. How a communication link 255 (not separately numbered) between the servers 210, 220, 230, the databases 215, 225, and 235, and/or another electronic device (not shown) and the communications network 250 is implemented will depend inter alia on how each electronic device is implemented.

The communication network 250 may be used in order to transmit data packets amongst the first server 210, the second server 220 and the third server 230. For example, the communication network 250 may be used to transmit requests from the first server 210 to the second server 220. In another example, the communication network 250 may be used to transmit data packets from the third server 230 to the first server 210.

### Flight Services Communication Platform

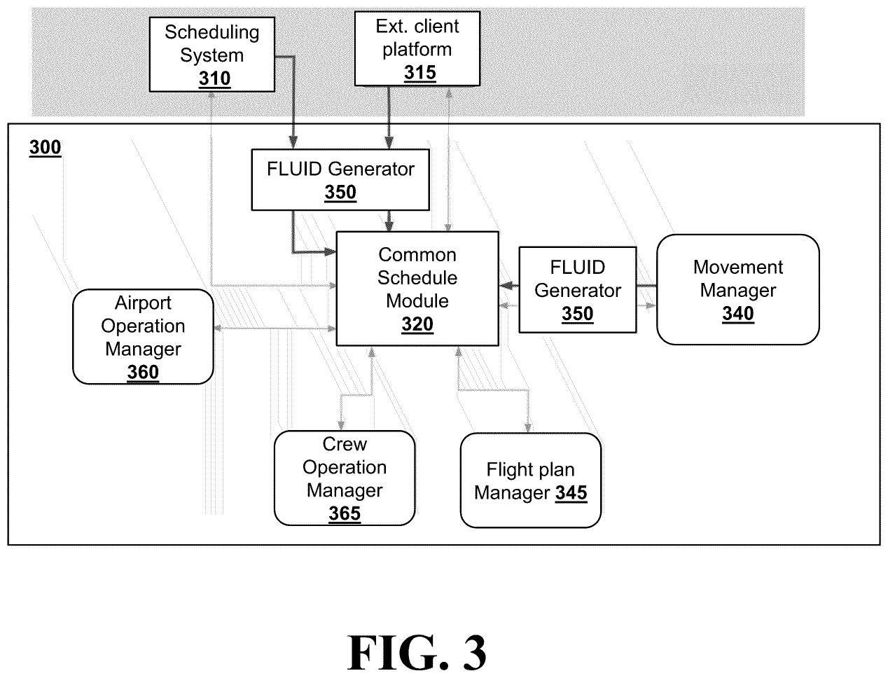

With reference to FIG. 3, there is shown a schematic diagram of a flight services communication platform 300 implemented in accordance with one or more non-limiting implementations of the present technology.

In one or more implementations, the flight services communication platform 300 may be implemented within the computing environment 200 of FIG. 2. In one or more implementations, the first server 210 and the second server 220 may execute the flight services communication platform 300.

The flight services communication platform 300 comprises at least the common schedule module 320 and a movement manager 340. The flight services communication platform 300 is configured to execute a flight leg unique identifier (FLUID) generator 350.

In the implementation illustrated in FIG. 3, the flight services communication platform 300 comprises the common schedule module 320 and the movement manager 340 which are connected to an airport operation manager 360, a crew operation manager 365 and a flight plan manager 345.

In one or more implementations, one or more of the airport operation manager 360, the crew operation manager 365 and the flight plan manager 345 within the flight services communication platform 300 may be optional and may executed by external entities.

The flight services communication platform 300 is connected to an external scheduling system 310 and an external client platform 315 (which may also be referred to as external third-party services 310 and 315). As a non-limiting example, the external scheduling system 310 and external client platform 315 may be executed by the third server 230.

In the context of the present technology, the flight services communication platform 300 uses the FLUID generator 350 to generate and assign a FLUID for each flight leg communicated within the flight services communication platform 300 and to the external scheduling system 310 and the external client platform 315, so as to ensure that all components refer to the same flight leg in a global and unique manner.

### Airport Operations Manager

In one or more implementations, the airport operations manager 360 is configured to communicate data between different modules through an airport operational database (AODB) or a similar system. The AODB may integrate data from different sources, such as flight information displays, gate assignment systems, baggage handling systems, and passenger information systems. The AODB may use standardized data formats, such as the Airport Collaborative Decision Making (A-CDM) data exchange format, to ensure compatibility and consistency across different modules.

As a non-limiting example, the airport operation manager 360 may be executed by the second server 220.

In one or more implementations, the AOC system may use standardized data formats, such as the Aeronautical Information Exchange Model (AIXM), to ensure compatibility and consistency across different modules.

The airport operations manager 360 uses a respective format for a given flight leg. As a non-limiting example, the airport operations manager 360 may define a flight leg as having one or more of a flight date, a carrier code, a service number, a routing code, passenger count data, cargo data, fuel data, weight data with/without fuel, a terminal code, gate/stand data where a given aircraft is expected to board/offboard, etc.

### Crew Operation Manager

The crew operation manager 365 is configured to determine the schedules and assignments of flight crews, which may be performed based on flight legs. As a non-limiting example, crew schedules may be determined based on the flight legs that they will be flying, taking into account factors such as duty time limits, rest requirements, and crew qualifications.

The crew operation manager 365 may use standardized data formats, such as the Crew Operations and Planning (COP) data model.

In one or more implementations, the crew operation manager 365 uses a respective format for a given flight leg. As a non-limiting example, the crew operation manager 365 may define a flight leg as having one or more of: a list of member pilot(s) and cabin crew, their qualifications and certifications, their duty and rest schedules, their locations and contact information, etc.

### Movement Manager

The movement manager 340 is configured to inter alia: (i) maintain synchronized operational schedule through comprehensive situational awareness; and (ii) manage optimal operation by exception, supported by comprehensive set of operational alerts.

In the context of the present technology, the movement manager 340 is configured as an operations systems control which inter alia manages the airline operations on day of flight (which aircraft is flying, what flight, procedures in case of exceptions (reroute, or other change).

It will be appreciated that the movement manager 340 has a respective definition of a flight leg. As a non-limiting example, the movement manager 340 may define a flight leg as having one or more of: a flight date, a carrier code, a service number, a departure port code, a departure terminal code, a departure time, an arrival port code, an arrival terminal code, an arrival time, a gate assignment, a terminal assignment, an arrival time, a departure/arrival gate assignment, a service type, a passengers booking figures, a payload details,, etc.

In one or more implementations, the movement manager 340 is configured to generate a new flight leg. It will be appreciated that the new flight leg may be a flight leg that did not exist before, or may be a modification to an existing flight leg. The movement manager 340 is configured to transmit an indication of the new flight leg to the FLUID generator 350. The FLUID generator 350 is configured to communicate the new flight leg and associated FLUID to the common schedule module 320.

### Flight Plan Manager

The flight plan manager 345 isa flight planning solution and is configured to inter alia create flight plans, which include the route that will be taken, altitude, gas required, plan, alt. airports, determines compliance with state or federal airline, regulations and the like.

The flight plan manager 345 may define a flight according to a specific format. It will be appreciated that the flight plan manager 345 has a respective definition of a flight leg. As a non-limiting example, in flight scheduling, a flight leg represents a specific segment of a flight that is included in a larger flight schedule. For example, a flight schedule might include a flight leg from New York to London, followed by a flight leg from London to Paris.

In one or more implementations, the flight plan manager 345 transmits an indication of each flight leg to the FLUID generator 350 such that a FLUID may be generated and assigned to the flight leg. It will be appreciated that that a flight schedule may thus include a plurality of flight legs, which will each be assigned a respective FLUID.

### Common Schedule Module

The common schedule module 320 is configured act as a central repository of data for performing data management across different domains. In one or more implementations, the common schedule module 320 has access to a collection of data domains that are used to enhance and streamline the integration between civil flight services platform (e.g., gate manager, gate planner, movement manager, etc.) and external third-party services (e.g., external scheduling system 310 and external client platform 315).

In the context of the present technology, the common schedule module 320 uses the FLUID generator 350 to generate a FLUID and to ensure a match with a FLUID when an event occurs with a flight operation (e.g., change of destination, delayed flight, cancelled flight, reinstated fight, or any other event that may happen with the flight) such that all components of the platform have a global unique identifier for a given flight leg.

The common schedule module 320 ensures that the FLUID is communicated consistently throughout the flight services communication platform 300 when reference to a given flight leg is transmitted, whatever the specific data format used in the transmission.

In one or more implementations, the common schedule module 320 is configured to receive an indication of a new flight leg and use the FLUID generator 350 to generate and assign a FLUID to the indication of the new flight leg.

Thus, when a new flight leg is generated by one or more of the common schedule module 320, the movement manager 340 or external scheduling system 310 by using the FLUID generator 350, the common schedule module 320 receives the FLUID having been generated by the FLUID generator 350 and the indication of the flight leg for which it was generated.

The common schedule module 320 is configured to store the association between the flight leg and its assigned FLUID for retrieval and future communications between components of the platform 300 and external third-party services (e.g., external scheduling system 310 and external client platform 315) so as to uniquely identify the flight leg

Thus, once components of the platform 300 and external third-party services 310, 315 receive the FLUID, every communication includes the FLUID generated by the FLUID generator 350.

As a non-limiting example, for a flight route comprising a plurality of flight legs, a given flight leg may change during operation of the aircraft due to an event (e.g., change of destination or emergency landing). The common schedule module 320 stores each FLUID assigned to the plurality of flights legs of the flight route, and continues to communicate the FLUID for the given flight leg to ensure consistency in communications between components of the platform 300 and the external third-party services 310, 315. In such cases, a recovery flight leg may be generated for the event (e.g., by the movement manager 340), which will be assigned a new FLUID and stored by the common schedule module 320, however the common schedule module 320 uses the FLUIDs for the flight route (which may include the FLUID of the original given flight leg and the FLUID recovery flight leg) to ensure that the flight services communication platform 300 and external third-party services 310, 315 have consistency in their communications.

### External Scheduling System

The external scheduling system 310 is configured to inter alia: generate and manage the schedules of one or more aircrafts. In one or more implementations, the scheduling system 310 is configured to obtain flight schedules based on factors such as aircraft availability, crew availability, passenger demand, and weather conditions. The scheduling system 310 may also be responsible for updating schedules in real time in response to changing conditions, such as delays or cancellations. It will be appreciated that the purpose of the scheduling system 310 is to optimize the use of aircraft resources while ensuring the safety and satisfaction of passengers.

In one or more implementations, the external scheduling system 310 is configured to implement a scheduling system to communicate data. The scheduling system 310 may be accessed by different departments within an airline, such as operations, crew scheduling, and ground handling. In one or more implementations, the scheduling system 310 may use standardized data formats, such as the International Air Transport Association (IATA) Schedule Information Standards (SIS), to ensure compatibility and consistency across different modules. It will be appreciated that the FLUID is assigned at the moment of creating the flight leg, and the same FLUID is used regardless of number of changes applied to that flight leg. Thus, the different systems such as one or more of the common schedule module 320, the movement manager 340, the airport operation manager 360, the crew operation manager 365 and the flight plan manager 345 including the external scheduling system 310 using the FLUID will exactly know what flight leg to modify, even though the key parameters of the flight leg (e.g., flight/service number, airports or times) may be modified.

In one or more implementations, the external scheduling system 310 uses a specific format to identify a flight. As a non-limiting example, the external scheduling system 310 may identify a flight not at a flight leg level, but as a flight number operating between two city pairs during a six-month period (at any given time).

The external scheduling system 310 may communicate with flight services communication platform 300 by generating a FLUID using the FLUID generator 350, which is stored in association with the identification of the flight by the common schedule module 320.

### External Client Platform

In one or more implementations, the external client platform 315 is configured to transmit data including one or more of flight date, carrier code, service number, routing code, passenger count data, cargo data, fuel data, weight data with/without fuel etc.

In one or more implementations, the external client platform 315 may be optional. In one or more other implementations, the external client platform 315 may execute functions similar to one or more of the schedule module 320, the movement manager 340, the airport operation manager 360, the crew operation manager 365 and the flight plan manager 345. It will be appreciated that the external client platform 315 may be under control of another entity.

As described above, the purpose of the present technology is to use a FLUID to identify changes and different formats that refer to the same flight such that components of the platform 300 (i.e., the common schedule module 320, the movement manager 340, the airport operation manager 360, the crew operation manager 365 and the flight plan manager 345) and the external scheduling system 310 and the external client platform 315 have a unique and consistent manner of identifying a flight leg.

The common schedule module 320, the movement manager 340, and the scheduling system 310 have access to the FLUID generator 350. The FLUID generator 350 may be executed within or integrated one of the common schedule module 320 and/or the movement manager 340. As a non-limiting example, the first server 210 may execute the FLUID generator 350.

### FLUID Generator

The FLUID generator 350 is configured to inter alia: (i) receive a request for a given flight leg; (ii) generate, based on the request, the FLUID; and (iii) transmit the FLUID.

In one or more implementations, the FLUID comprises at least three portions: a first portion, a second portion and a third portion.

In one or more implementations, to generate the FLUID, the FLUID generator 350 is configured to: (i) generate the first portion of the FLUID based on a timestamp associated with the indication of the flight leg; (ii) generate a second portion of the FLUID based on an identifier of a source of the request for the given flight leg; and (iii) generate a third portion of the FLUID based on an indication of a random number.

In one or more implementations, the FLUID has a fixed length.

The FLUID generator 350 generates the first portion of the FLUID based on a timestamp associated with the new given flight leg.

In one or more implementations, the timestamp corresponds to a reception time of the request by the FLUID generator 350. In one or more other implementations, the timestamp corresponds to a creation time of the new given flight leg by the source before transmission of the request to the FLUID generator 350.

In one or more other implementations, the source system may be predetermined source system. In one or more implementations, the source system may be a new or not previously known source, and a new code may be assigned based on a agreement between the flight services communication platform 300 and the new or not previously known source.

In one or more implementations, the FLUID generator 350 is configured to receive the timestamp, convert the timestamp into an intermediate format, and generate, based on the intermediate format, the first portion of the FLUID. As a non-limiting example, the flight leg may be created at: 2021 Apr. 22 12:34:20.579, the timestamp converted in milliseconds may be: 1619094860579, and the first portion of the FLUID may be obtained by converting the timestamp in milliseconds into a hexadecimal (base16) format to obtain the first portion of the FLUID as 178F992F323. In one or more implementations, the hexadecimal format of the first portion of the FLUID comprises 11 characters, and if the hexadecimal value is shorter than 11 characters, the string may be padded with 0s.

The FLUID generator 350 generates the second portion of the FLUID based on an identification of the source system of the request.

In one or more implementations, the request comprises an indication of the source system. In one or more other implementations, the indication of the source system may be transmitted at a different time. In one or more implementations, the source system is at least one of the common schedule module 320, the external scheduling system 310 and the movement manager 340.

In one or more implementations, codes may have been assigned to each of the sources. The codes may be, as a non-limiting example, in hexadecimal format.

In one or more implementations, the codes may be associated with software and/or hardware identifiers of the requestor(s). As a non-limiting example, the FLUID generator 350 may store, for each of the common schedule module 320, the movement manager 340, and the external scheduling system 310, a respective source system code.

The indication of the random number may be received from a random number generator. The FLUID generator 350 generates the third portion of the FLUID via the random number generator.

In one or more implementations, the random number generator may be one or more of: a true random number generator (TRNG), a pseudo random number generator (PRNG) and cryptographically secure pseudo random number generator (CSPRNGs).

The FLUID generator 350 receives the indication of the random number, and generates, based on the indication of the random number, the third portion of the FLUID in a hexadecimal format.

The FLUID generator 350 combines the first FLUID portion, the second FLUID portion and the third FLUID portion to obtain the FLUID. In one or more implementations, a fourth FLUID portion is located between the first FLUID portion and the second FLUID portion and the fifth FLUID portion is located between the second the third FLUID portion. The fourth FLUID and the fifth FLUID portions may be characters used as separators.

It will be appreciated that the combination may include different operations depending on how the portions of the FLUID are implemented. As a non-limiting example, to FLUID generator 350 may perform a concatenation of the FLUID portions to obtain the FLUID.

As a non-limiting example, the FLUID may be of a fixed length of 28 characters. The FLUID may include: 11 characters for an encoded timestamp (first portion), 1 character as a separator, 3 characters for an encoded source system code (second portion), 1 character as a separator, and 12 characters for an encoded random value (third portion).

The FLUID generator 350 outputs the FLUID.

The FLUID generator 350 transmits the FLUID to originator of the request, i.e., the source system. It will be appreciated that source system may be one of the common schedule module 320, the external scheduling system 310 and/or the movement manager 340.

In one or more implementations, the FLUID generator 350 transmits the FLUID and the new given flight leg to the other source system i.e., one of the common schedule module 320, the movement manager 340 and/or the external scheduling system.

In one or more implementations, the FLUID generator 350 may be executed within or integrated one of the common schedule module 320 and/or the movement manager 340.

In one or more other implementations, the external scheduling system 310 that has been previously authorized by the platform 300 may send requests for generating a FLUID to the FLUID generator 350. In such implementations, the FLUID generator 350 transmits the generated FLUID to the common schedule module 320, which stores association of the FLUID with the flight leg and communicates the flight leg, as well as transmitting the FLUID to the external scheduling system 310.

In the illustrated non-limiting implementation, the pre-authorized external scheduling system 310 may transmit a request comprising an indication of a new flight leg to the FLUID generator 350, which causes the FLUID generator 350 to generate a respective FLUID. The FLUID generator 350 transmits the FLUID and the indication of the new flight leg to the common schedule module 320, and to the pre-authorized external scheduling system 310. It will be appreciated that if an external system such as the external scheduling system 310 is authorized to generate the FLUID, it must also transmit the generated FLUID and the indication of the new flight leg to the common schedule module 320.

The common schedule module 320 receives the FLUID and the flight leg. The common schedule module 320 is configured to store the FLUID and the flight leg in association in a database, such as the database 215.

In one or more implementations, the common schedule module 320 verifies if the flight leg is present in the database 215.

In one or more implementations, the common schedule module 320 receives an indication of an event for a given flight, which causes the common schedule module 320 to verify if the given flight leg is present in the database 215, identify the FLUID associated with the given flight leg and transmit the given flight leg with the associated FLUID to other components of the platform 300 (i.e., the common schedule module 320, the movement manager 340, the airport operation manager 360, the crew operation manager 365 and the flight plan manager 345) and the external scheduling system 310 and the external client platform 315

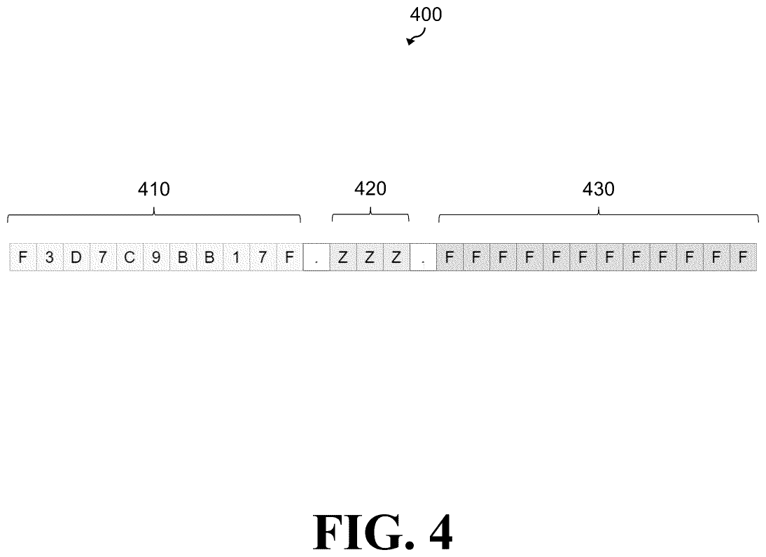

FIG. 4 illustrates a non-limiting example of a FLUID 400 that may be generated by the FLUID generator 350 of FIG. 3.

The FLUID 400 comprises a first portion 410, a second portion 420 and a third portion 430.

In the illustrated example, the first portion 410 comprises 11 characters, the second portion 420 comprises 3 characters and the third portion 430 comprises 12 characters.

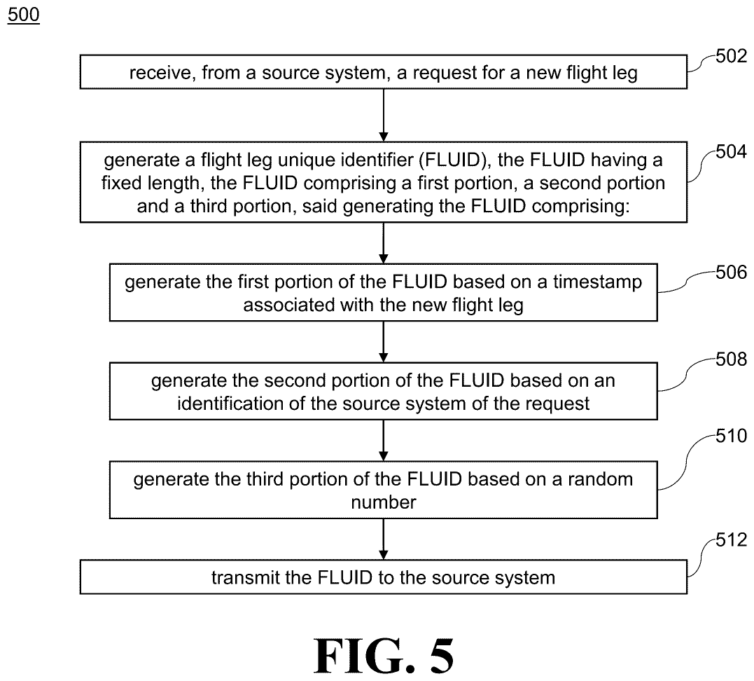

Now turning to FIG. 5, there is shown a flow chart of a method 500 of generating a FLUID in accordance with one or more non-limiting implementations of the present technology.

### Method Description

In one or more implementations. at least one processor such as the processor 110 and/or the GPU 111 (FIG. 1) is operatively connected to a non-transitory computer-readable storage medium such as the solid-state drive 120 and/or the random-access memory 130 (FIG. 1) storing computer-readable instructions. The at least one processor, upon executing the computer-readable instructions, is configured to or operable to execute the method 500.

In one or more implementations, the method 500 is executed within the computing environment 200 of FIG. 2.

The method 500 begins at processing step 502.

At processing step 502, the at least one processor receives a request for a new flight leg. In one or more implementations, the request is received from a source system. At least one field of the new flight leg recorded by the source system.

In one or more implementations, the source system is one of the common schedule module 320, the external scheduling system 310 and/or the movement manager 340 of FIG. 3.

In one or more alternative implementations, the source system of the request is a predetermined source system.

At processing step 504, the at least one processor generates a flight leg unique identifier (FLUID). In one or more implementations, the FLUID comprises a first portion, a second portion and a third portion. In one or more implementations, processing step 504 comprises processing steps 506-510.

In one or more implementations, the FLUID has a fixed length.

At processing step 506, the at least one processor generates a first portion of the FLUID based on a timestamp associated with the new flight leg.

At processing step 508, the at least one processor generates a second portion of the FLUID based on an identification of the source system of the request.

At processing step 510, the at least one processor generates a third portion of the FLUID based on a random number. In one or more implementations, the at least one processor receives the random number and generates the third portion on the received random number. In one or more implementations, the at least one processor generates, using a pseudo random number generator (PRNG), the random number.

In one or more alternative implementations, the at least one processor uses one or more of a true random number generator (TRNG), a pseudo random number generator (PRNG) and a cryptographically secure pseudo random number generator (CSPRNGs) to obtain the random number.

The at least one processor combines the first FLUID portion, the second FLUID portion and the third FLUID portion to obtain the FLUID.

At processing step 512, the at least one processor transmits the FLUID to the source system.

In one or more implementations, the at least one processor stores the FLUID and an indication of the associated flight leg in a non-transitory storage medium. As a non-limiting example, the at least one processor may store the FLUID and indication of the associated new flight leg in the database 215.

The method 500 then ends.

It should be expressly understood that not all technical effects mentioned herein need to be enjoyed in each and every implementation of the present technology. For example, implementations of the present technology may be implemented without the user enjoying some of these technical effects, while other non-limiting implementations may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

1. A computer-implemented method for generating and transmitting a flight leg unique identifier (FLUID) for a flight leg, the method being executed by at least one processor, the at least one processor being connected to a source system, the method comprising:
receiving, from the source system, a request for a new flight leg, with at least one field of the new flight leg recorded in the source system;
generating a flight leg unique identifier (FLUID), the FLUID comprising a first portion, a second portion and a third portion, said generating the FLUID comprising:
generating the first portion of the FLUID based on a timestamp associated with the new flight leg;
generating the second portion of the FLUID based on an identification of the source system of the request; and
generating the third portion of the FLUID based on a random number; and
transmitting the FLUID with the at least one field of the new flight leg to the source system,
wherein the flight leg unique identifier comprises a computer-readable identifier readable by at least one of plurality of computer systems.

2. The method of claim 1, wherein the request further comprises an indication of the new flight leg, and wherein the at least one processor is further configured to transmit the FLUID together with the indication of the new flight leg.

3. The method of claim 1, wherein the timestamp corresponds to a creation time of the new flight leg.

4. The method of claim 1, wherein the timestamp corresponds to a reception time of the request.

5. The method of claim 1, wherein said generating the third portion of the FLUID comprises:
generating, using a pseudo random number generator (PRNG), the random number.

6. The method of claim 1, wherein the FLUID is in hexadecimal format.

7. The method of claim 1, wherein the first portion of the FLUID comprises 11 characters, the second portion of the FLUID comprises 3 characters, and the third portion of the FLUID comprises 12 characters.

8. The method of claim 7, wherein the FLUID comprises a fourth portion having 1 character positioned between the first portion and the second portion, and a fifth portion having 1 character positioned between the second portion and the third portion.

9. The method of claim 8, wherein the FLUID has a fixed length of 28 characters.

10. The method of claim 1, wherein the source system comprises one of a schedule management system and a flight operation control system.

11. The method of claim 10, wherein the request comprises the identification of the source system.

12. The method of claim 1, wherein the at least one processor is operatively connected to a database and configured to store the FLUID with the indication of the new flight leg in the database.

13. The method of claim 1, wherein the plurality of computer systems comprises a common schedule system, a movement system, an airport operation system, a crew operation system and a flight plan system.

14. A system for generating and transmitting a flight leg unique identifier (FLUID) for a flight leg, the system comprising:
a non-transitory storage medium storing computer-readable instructions thereon; and
at least one processor operatively connected to the non-transitory storage medium,
the at least one processor, upon executing the computer-readable instructions, being configured for:
receiving, from a source system operatively connected to the at least one processor, a request for a new flight leg, with at least one field of the new flight leg recorded in the source system;
generating a flight leg unique identifier (FLUID), the FLUID comprising a first portion, a second portion and a third portion, said generating the FLUID comprising:
generating the first portion of the FLUID based on a timestamp associated with the new flight leg;
generating the second portion of the FLUID based on an identification of the source system of the request; and
generating the third portion of the FLUID based on a random number; and
transmitting the FLUID with the at least one field of the new flight leg to the source system,
wherein the flight leg unique identifier comprises a computer-readable identifier readable by at least one of a plurality of computer systems.

15. The system of claim 14, wherein the request further comprises an indication of the new flight leg, and wherein the at least one processor is further configured for transmitting the FLUID together with the indication of the new flight leg.

16. The system of claim 14, wherein the FLUID is in hexadecimal format.

17. The system of claim 14, wherein the first portion of the FLUID comprises 11 characters, the second portion of the FLUID comprises 3 characters, and the third portion of the FLUID comprises 12 characters.

18. The system of claim 14, wherein the source system comprises one of a schedule management system and a flight operation control system.

19. The system of claim 14, wherein the at least one processor is operatively connected to a database and configured to store the FLUID with the indication of the new flight leg in the database.

20. The system of claim 14, wherein the plurality of computer systems comprises a common schedule system, a movement system, a airport operation system, a crew operation system and a flight plan system.

21. The method of claim 1, further comprising: transmitting the FLUID to another system.

22. The system of claim 15, wherein the at least one processor is further configured for: transmitting the FLUID to another system different from the source system.
